(19) United States
(12) Patent Application Publication
(10) Pub. No.: US 2024/0379087 A1
(43) Pub. Date: Nov. 14, 2024

(54) ACOUSTIC ARTICLES AND METHODS OF MAKING THE SAME

(71) Applicant: 3M INNOVATIVE PROPERTIES COMPANY, St. Paul, MN (US)

(72) Inventors: Nicole D. Petkovich, Little Canada, MN (US); Yongbeom Seo, Woodbury, MN (US); Tongyang Shi, Woodbury, MN (US); Michael R. Berrigan, Oakdale, MN (US); Michelle M. Mok, St. Paul, MN (US); Seungkyu Lee, Cupertino, CA (US); Jonathan H. Alexander, Roseville, MN (US)

(21) Appl. No.: 18/691,974

(22) PCT Filed: Aug. 24, 2022
(86) PCT No.: PCT/IB2022/057937

§ 371 Date: Mar. 14, 2024

Related U.S. Application Data
(60) Provisional application No. 63/261,217, filed on Sep. 15, 2021.

(51) Int. Cl. G10K 11/165

(52) U.S. Cl. CPC G10K 11/165

(57) ABSTRACT

An acoustic article (10) comprising a porous layer (14) and an acoustic absorbing filler (18) embedded within the porous layer, and methods of making the same. The acoustic absorbing filler includes agglomerates comprising porous amorphous silica particles and a binder. The acoustic absorbing filler has a median sieved particle size of 100 i.un to 2000 i.un. The acoustic article has a normal incidence acoustic absorption of no less than 0.09 a at 400 Hz.

### BACKGROUND

Developments in automotive and aerospace technology have historically been driven by consumer demands for faster, safer, quieter, and more spacious vehicles. These attributes must be balanced against the desire for greater fuel efficiency, since the solutions to such demands tend to increase the weight of a vehicle which, in turn, leads to increased fuel consumption. Therefore, automotive and aerospace manufacturers are incentivized to meet consumer demands while simultaneously striving to reduce the overall weight of the vehicle. For example, a 10% vehicle weight reduction is capable of providing about an 8% increase in fuel efficiency. However, noise can become more problematic as the weight of a vehicle decreases.

Noise typically originates from structural vibrations that generate airborne noise in the form of sound waves. Structural vibrations are conventionally controlled at the source using damping materials made with heavy, viscous materials. Airborne noise is conventionally controlled using a soft, pliable material, such as a fiber or foam, capable of absorbing the sound waves.

### SUMMARY

The present disclosure provides an article for absorbing sound waves generated from a variety of sources, including the vibrations of automotive and aerospace vehicles.

In one embodiment, the present disclosure provides an acoustic article comprising: a porous layer; and an acoustic absorbing filler embedded in the porous layer, the acoustic absorbing filler comprising agglomerates, the agglomerates comprising porous amorphous silica particles and a binder, wherein the acoustic absorbing filler has a median sieved particle size of 100 μm to 2000 μm, more particularly 100 μm to 710 μm, and wherein the acoustic article has a normal incidence acoustic absorption of no less than 0.09 α at 400 Hz.

In some embodiments, the porous amorphous silica particles comprise a fumed silica, a silica gel, or combinations thereof. The porous amorphous silica particles can be mesoporous, microporous, or combinations thereof.

In some embodiments, the acoustic absorbing filler comprises 15 to 90 wt % porous amorphous silica particles. In the same or different embodiments, the acoustic absorbing filler comprises 10 to 85 wt % binder.

In some embodiments, the binder comprises clay, liquid alkali silicates, silicon alkoxides, boehmite, pseudoboehmite, lignin, lignosulfonates, polyacrylates, acrylic-copolymers, polyvinylpyrrolidone, polyvinyl alcohol, acrylamides, styrenic polymers, butadiene co-polymers, polyethylene glycol, polyethylene oxide, cellulosics, polysaccharides or combinations thereof.

In some embodiments, the binder comprises a polyacrylate, a clay, or combinations thereof.

In some embodiments, the porous layer is a perforated film having a plurality of perforations, wherein the acoustic absorbing filler resides in at least a portion of the plurality of perforations.

In some embodiments, the porous layer is a packed particle bed comprising the acoustic absorbing filler. In some embodiments, the acoustic article comprising the packed particle bed has a normal incidence acoustic absorption of no less than 0.2 α at 400 Hz.

In some embodiments, the porous layer is a nonwoven fibrous layer. In some embodiments, the nonwoven fibrous layer comprises blown microfibers (BMF). In some embodiments, the acoustic article comprising the nonwoven fibrous layer has a normal incidence acoustic absorption of no less than 0.1 α at 400 Hz.

In another embodiment, the present disclosure provides a method of making the acoustic articles described above comprising embedding the acoustic absorbing filler into the porous layer. In some embodiments, the acoustic absorbing filler is embedded into a nonwoven fibrous layer.

In another embodiment, the present disclosure provides an acoustic absorbing filler comprising: agglomerates comprising porous amorphous silica particles and a binder, wherein the acoustic absorbing filler has a median sieved particle size of 100 μm to 710 μm. In some embodiments, the binder comprises a polyacrylate, clay or combinations thereof.

The above summary of the present disclosure is not intended to describe each disclosed embodiment or every implementation of the present disclosure. The description that follows more particularly exemplifies illustrative embodiments.

### BRIEF DESCRIPTION OF THE DRAWINGS

FIG. 1 is a schematic cross-sectional view of an exemplary embodiment of an acoustic article of the present disclosure;

FIG. 2 is a schematic cross-sectional view of another exemplary embodiment of an acoustic article of the present disclosure:

FIG. 3 is an SEM image of EX-2 of the present disclosure; and

FIG. 4 is an SEM image of EX-4 of the present disclosure.

With reference to the figures, like reference numbers offset by multiples of 100 (e.g., 18, 118) indicate like elements. Unless otherwise indicated, all figures and drawings in this document are not to scale and are chosen for the purpose of illustrating different embodiments of the invention. In particular, the dimensions of the various components are depicted in illustrative terms only, and no relationship between the dimensions of the various components should be inferred from the drawings, unless so indicated.

### DETAILED DESCRIPTION

In the following description of illustrative embodiments, reference is made to the accompanying figures of the drawing which form a part hereof, and in which are shown, by way of illustration, specific embodiments. It is understood that the invention is not limited in its application to the details of use, construction, and the arrangement of components set forth in the following description. The invention is capable of other embodiments and of being practiced or of being carried out in various ways that will become apparent to a person of ordinary skill in the art upon reading the present disclosure.

As used herein:

The term “comprises” and variations thereof do not have a limiting meaning where these terms appear in the description and claims. Such terms will be understood to imply the inclusion of a stated step or element or group of steps or elements but not the exclusion of any other step or element or group of steps or elements. By “consisting of” is meant including, and limited to, whatever follows the phrase “consisting of.” Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they materially affect the activity or action of the listed elements.

The terms “a,” “an,” and “the” are used interchangeably with “at least one” to mean one or more of the components being described.

The term “and/or” means one or all of the listed elements or a combination of any two or more of the listed elements.

The term “substantially” with reference to a property or characteristic means that the property or characteristic is exhibited to a greater extent than the opposite of that property or characteristic is exhibited.

The term “some embodiments” means that a particular feature, configuration, composition, or characteristic described in connection with the embodiment is included in at least one embodiment of the disclosure. Thus, the appearances of such phrases in various places throughout this specification are not necessarily referring to the same embodiment of the disclosure. Furthermore, the particular features, configurations, compositions, or characteristics may be combined in any suitable manner in one or more embodiments.

The terms “preferred” and “preferably” refer to embodiments of the disclosure that may afford certain benefits, under certain circumstances: however, other embodiments may also be preferred, under the same or other circumstances. Furthermore, the recitation of one or more preferred embodiments does not imply that other embodiments are not useful, and is not intended to exclude other embodiments from the scope of the disclosure.

The term “aerogel” refers to a three-dimensional porous solid that is derived from a gel composition, in which the liquid component of the gel has been replaced with a gas. The solvent removal is often done under supercritical conditions. During this process the network does not substantially shrink and a highly porous, low-density material can be obtained.

The term “average” means number average, unless otherwise specified.

The term “basis weight” is calculated as the weight of a 10 cm×10 cm web sample multiplied by 100, and is expressed in grams per square meter (gsm).

The term “copolymer” refers to polymers made from repeat units of two or more different polymers and includes random or statistical, gradient, alternating, block, graft, and star (e.g. dendritic) copolymers and combinations thereof.

The term “dimensionally stable” refers to a structure that substantially holds its shape under gravity unassisted (i.e., not floppy).

The term “die” means a processing assembly including at least one orifice for use in polymer melt processing and fiber extrusion processes, including but not limited to melt-blowing.

The term “embedded” means that particles are dispersed and physically and/or adhesively held in a porous layer.

The term “glass transition temperature (or T_{g})” of a polymer refers to a temperature at which there is a reversible transition in an amorphous polymer (or in an amorphous region within a semi crystalline polymer) from a hard and relatively brittle “glassy” state into a viscous, rubbery (elastic), or viscoelastic state as the temperature is increased.

The term “median fiber diameter” of fibers in a non-woven fibrous layer is determined by producing one or more images of the fiber structure, such as by using a scanning electron microscope: measuring the transverse dimension of clearly visible fibers in the one or more images resulting in a total number of fiber diameters; and calculating the median fiber diameter based on that total number of fiber diameters.

The term “non-woven fibrous layer” means a plurality of fibers characterized by entanglement or point bonding of the fibers to form a sheet or mat exhibiting a structure of individual fibers or filaments which are interlaid, but not in an identifiable manner as in a knitted or woven fabric.

The term “oriented” when used with respect to a fiber means that at least portions of the polymer molecules within the fiber are aligned with the longitudinal axis of the fiber, for example, by use of a drawing (or stretching) process or attenuator upon a stream of fibers exiting from a die.

The term “particle” refers to a small distinct piece or individual part of a material in finely divided form. A particle may also include a collection of individual particles associated or clustered together in finely divided form. Thus, individual particles used in certain exemplary embodiments of the present disclosure may clump, physically intermesh, electrostatically associate, or otherwise associate to form clustered or aggregated particles.

The term “polymer” means a relatively high molecular weight material having a molecular weight of at least 2,000 g/mol or more than 20 repeat units.

The term “porous” means air-permeable.

The term “shrinkage” means reduction in the dimension of a fibrous non-woven layer after being heated to 150° C. for 7 days based on the test method described in U.S. Patent Publication No. 2016/0298266 (Zillig et al.).

The term “silica” refers to various stoichiometric formulas for silicon oxide. The most typical stoichiometric formula is SiO₂, which is generally referred to as either silicon oxide or silicon dioxide.

The term “size” refers to the longest dimension of a given object or surface.

The term “solvogel” means a three-dimensional porous solid that is derived from a gel composition that has been further processed by exchanging the initial, higher surface energy solvent for one with lower surface energy before evaporating the exchanged solvent under ambient conditions or at an elevated temperature.

The term “surface area” refers to the specific surface area, unless noted otherwise. This quantity for a material is the surface area normalized by unit mass.

The term “xerogel” refers to a three-dimensional porous solid that is derived from a gel composition that has been further processed to remove the solvent medium by evaporation under ambient conditions or at an elevated temperature.

All numbers are assumed to be modified by the term “about”. As used herein in connection with a measured quantity, the term “about” refers to that variation in the measured quantity as would be expected by the skilled artisan making the measurement and exercising a level of care commensurate with the objective of the measurement and the precision of the measuring equipment used.

The recitations of numerical ranges by endpoints include all numbers subsumed within that range as well as the endpoints (e.g., 1 to 5 includes 1, 1.5, 2, 2.75, 3, 3.80, 4, 5, etc.). The phrase “up to” a number (e.g., up to 50) includes the number (e.g., 50).

The present disclosure provides acoustic articles that function as acoustic absorbers and/or acoustic and thermal insulators, and methods of making the same. The acoustic articles generally include one or more porous layers and one or more acoustic absorbing fillers in contact with the one or more porous layers. Optionally, the provided acoustic articles include one or more non-porous barrier layers and/or air gaps adjacent to the one or more porous layers. Structural and functional characteristics of each of these components are described in the subsections that follow.

### Acoustic Fillers

The acoustic absorbing filler of the present disclosure includes agglomerates comprising porous amorphous silica particles and a binder. The porous amorphous silica particles, herein also referred to as “porous particles”, may be uniformly or nonuniformly distributed within the binder as isolated particles, aggregated particles, or combinations thereof.

The porous particles of the acoustic absorbing filler are amorphous. That is, the porous particles contain less than 0.1 wt % crystalline silica, which can be determined by, for example, x-ray diffractometry. The source of the porous particles is not particularly limited and may comprise precipitated solids, fine powders, and gels (e.g., aerogels, xerogels and solvogels).

Porous particles may be produced, for example, by chemical precipitation (precipitated silica), pyrolysis (fumed or pyrogenic silica), or sol-gel processing (xerogels, solvogels, or aerogels). In some embodiments, the porous particles comprise a fumed silica, a gel, or combinations thereof. Precipitated silica consists of fine particles of condensed silica generally formed by manipulation of the pH of an aqueous solution containing silicate species. Fumed silica is produced by aerosolizing a silica precursor and exposing it to a flame that rapidly converts it to a fine powder of aggregated nanoscale particles. Sol-gel silica is produced by a controlled hydrolysis and condensation of a monomeric silica precursor, often a silicon alkoxide species or monomeric/polymeric soluble silica in an alkaline solution, ultimately forming a cross-linked gel. Alternately, one can start with a silica colloid that, under the right reaction conditions, can form particle gel network. Depending on the processing conditions used for the removal of the solvent phase, one can obtain materials with extremely low density and extensive porosity using supercritical drying (e.g., aerogels) or higher density materials arising from pore collapse due to drying stresses (e.g., xerogels). Additional porosity can be added to sol-gel silica through surfactant-templating or the formation of an emulsion (or both): however, these materials have additional processing costs associated with the precise conditions needed to allow for formation of a template/emulsion and the costs associated with their removal.

In some embodiments, the porous particles may be surface modified. The surface modified porous particles are a reaction product of the surface of the silica particles with one or more surface modifying agents. For example, in one embodiment, the surface modifying agent contains a silyl group that reacts with a silanol group on the surface of the silica particles and at least one other group that is compatible with the binder in the acoustic absorbing filler. In the same or different embodiments, the surface modifying agent contains at least one radically polymerizable group. In some embodiments, the surface of the porous particles is modified with additional surface modifying agents in addition to the modifying agent having a radically polymerizable group. Examples of suitable porous particles that have been surface modified are disclosed, for example, in International Patent Publication No. WO 2018/044565 (Humpal, et al.), although the fluorinated and halogenated surface modifiers are less preferred due to incompatibility with many of the above-described binders. Other suitable surface modified porous particles can be found in Studies in Surface Science and Catalysis: Characterization and Chemical Modification of the Silica Surface by E. F. Vansant, P. Van Der Voort, and K. C. Vrancken, Elsevier, 1995, Chapters 8 and 13.

The porous particles can include mesopores (having a diameter from 2 to 50 nanometers), micropores (having a diameter less than 2 nanometers), or combinations thereof. The pore structure within the particles can be ordered and/or disordered. In some embodiments, the pore structure is a disordered worm-like structure. In some embodiments, the pore structure is an ordered hexagonal array of parallel cylinders.

Examples of commercially available porous particles include: Cabot's Cab-O-Sil line from Cabot Corporation in Boston MA: PPG's Hi-Sil line from PPG Industries in Pittsburgh, PA: Heraeus Zandosil from Heraeus Group in Hanau Germany: MCM-41 available from ACS Material, LLC in Pasadena, CA: Premium Quality Type B silica gel available from Wisesorbent Technologies in Marlton, NJ, USA: AW0210G Type A silica gel available from Interra Global Corporation in Park Ridge, IL, USA; and AEROPERLR 300/30 available from Evonik Industries AG, Essen, Germany.

The binder can include any suitable binder that is compatible with the porous particles. Exemplary binders include clay, liquid alkali silicates, silicon alkoxides, boehmite, pseudoboehmite, lignin, lignosulfonates, polyacrylates, acrylic-copolymers, polyvinylpyrrolidone, polyvinyl alcohol, acrylamides, styrenic polymers, butadiene co-polymers, polyethylene glycol, polyethylene oxide, cellulosics, polysaccharides or combinations thereof. In some embodiments, the binder comprises a polyacrylate. In at least one embodiment, the polyacrylate binder can be heat activated to deform and form cohesive networks between particles on cooling. In some embodiments, the binder comprises clay. In yet further embodiments, the binder comprises a polyacrylate and clay. The binder is not made up of porous amorphous silica particles: nor are the porous amorphous silica particles made up of binder.

The porous amorphous silica particles can be present in an amount of less than 90%, 80%. 70%, 60%, 50%, 40%, 35%, 30%, 20%, or 15% by weight relative to the overall weight of acoustic absorbing filler. In some embodiments, the acoustic absorbing filler comprise 15 to 90% or 25 to 75% by weight of porous amorphous silica particles. The binder can be present in an amount of more than 10%, 20%, 30%, 40%, 50%, 60%, 65%, 70%, 80%, or 85% by weight relative to the overall weight of acoustic absorbing filler. In some embodiments, the acoustic absorbing filler comprises 10 to 85% or 25 to 75% by weight binder.

The porous particles and binder of the acoustic absorbing filler form agglomerates that may be regularly or irregularly shaped. The acoustic absorbing filler has a median sieved particle size of from 100 micrometers to 2000 micrometers, from 100 micrometers to 1000 micrometers, from 100 micrometers to 900 micrometers, or from 100 micrometer to 700 micrometers, or in some embodiments, less than, equal to, or greater than 100, 200, 300, 400, 500, 600, 700, 800, 900, 1000, 1200, 1500, 1700, or 2000 micrometers. In some embodiments, the acoustic absorbing filler has a median sieved particle size of from 100 micrometers to 710 micrometers.

Owing to its porous nature, especially on the nanoscale (<50 nm), it is possible for the acoustic absorbing filler to have a high surface area, and consequently, adsorption capacity. A reduction in the bulk modulus of the air in the space proximate to the filler is possible by harnessing this reversible adsorption and desorption of gas molecules on the filler and by harnessing how gas molecules diffuse in nanopores. When the bulk modulus of air is decreased, lower frequency noise can be dissipated by thinner constructs than would be predicted by standard acoustic models. Without wishing to be bound by theory, while the nanoscale porosity alters the bulk modulus of surrounding air, dissipation of the energy in a sound wave (e.g., via acoustic absorption) occurs due to thermal and viscous effects at larger length scales than those that typify the micro- and mesoporosity.

Surface area can be measured based on the sorption of various pure gases (such as diatomic nitrogen gas or carbon dioxide) onto the surface of a given material. These measurements can be performed using an instrument known a gas sorption analyzer. In this measurement, one can generate an isotherm (volume of gas adsorbed at standard temperature and pressure per unit mass versus relative pressure) by dosing a sample with gas. By applying a modified form of the Langmuir equation known as the Brunauer-Emmett-Teller (BET) equation to the isotherm, it is possible to calculate the surface area. This value is known as the BET (specific) surface area, or the multi-point BET surface area (MBET surface area) if multiple points of the isotherm are used in the equation. In some embodiments, the surface area, as referred to herein, is the BET surface area.

The specific surface area of the acoustic absorbing filler can be from 0.1 m²/g to 1000 m²/g, from 0.5 m²/g to 1000 m²/g, from 1 m²/g to 1000 m²/g, from 50 m²/g to 900 m²/g, from 70 m²/g to 640 m²/g, or in some embodiments, less than, equal to, or greater than 0.1 m²/g, 0.2, 0.5, 0.7, 1, 2, 5, 10, 20, 50, 100, 120, 150, 200, 250, 300, 350, 400, 450, 500, 900, or 1000 m²/g.

Additionally, when the energetics of sorption are known, and general model of the pore structure exists, one can model the adsorption of a fluid on a solid phase for given equilibrium state (i.e. a global minimum) for the grand potential of the overall thermodynamic system. Density functional theory (DFT) is frequently employed to perform this analysis, which provides more accurate results than the simplified BET equation. Quenched state DFT (QSDFT) models are preferably employed when available, as they are two-component, accounting for the energetics of solid-solid interactions. These DFT models allow for analysis of the amount of surface area provided for a given range (or bin) of pore diameters. In some embodiments, the surface area, as referred to herein, is the QSDFT surface area for a specific range of pore diameters. From these analyses, one can also determine if a material contains primarily micropores, mesopores, macropores (pores with a diameter greater than 50 nm), or hierarchical porosity (smaller pores nested within larger pores).

The acoustic absorbing filler can have a total pore volume of from 0.05 cm³/g to 2 cm³/g, from 0.1 cm³/g to 1.0 cm³/g, or from 0.3 cm³/g to 1.0 cm³/g. In some embodiments, the total pore volume can be less than, equal to, or greater than, 0.05 cm³/g, 0.07, 0.1, 0.2, 0.3, 0.4, 0.5, 0.7, 1, 1.2, 1.4, 1.6, 1.8, or 2 cm³/g. This value can be determined using DFT analysis, or via analysis of the volume of gas adsorbed at a pressure (P) close to the saturation point (P₀), typically at a relative pressure (P/P₀) of 0.995. Similar to what is mentioned above, DFT can also be used to analyze the amount of specific pore volume provided for a given range (or bin) of pore sizes.

When tested as a packed bed with 20 mm thickness, the acoustic absorbing filler has a normal incidence acoustic absorption of more than 0.20, 0.30, 0.40, or 0.50 alpha at 400 Hz, in some embodiments, for systems not exhibiting one or more resonance peak at low frequencies.

The acoustic absorbing filler of the present disclosure can have equivalent or improved acoustic performance in a packed bed configuration or when integrated into an acoustic article though it has a lower specific surface area and pore volume than the filler comprising only porous particulates, for example, pure, unmilled activated carbon. The acoustic absorbing filler of the present disclosure has a lower specific surface area because it has both porous particulates and binder, yet can match the performance of particles with much higher surface area, contrary to what is known in the art.

### Porous Layers

The provided acoustic articles include one or more porous layers. Useful porous layers include, but are not limited to, non-woven fibrous layers, perforated films, particle beds, open-celled foams, nets, woven fabrics, structured films, and combinations thereof.

Engineered non-woven fibrous layers containing fine fibers can be effective sound absorbers in aerospace, automotive, shipping, and building applications. Non-woven materials having a plurality of fine fibers can be especially effective at high sound frequencies, a regime in which the surface area of the structure promotes viscous dissipation of sound energy. Non-woven layers may be made from inorganic materials such as fiberglass, basalt, silicate compounds, alumina, and aluminosilicates. Polymeric non-woven layers can be made, for example, by melt blowing or melt spinning.

In melt-blowing, one or more thermoplastic polymer streams are extruded through a die containing closely arranged orifices and attenuated by convergent streams of hot air at high velocities to form fine fibers. These fine fibers can be collected on a surface to provide a melt-blown non-woven fibrous layer. Depending on the operating parameters chosen, e.g., degree of solidification from the molten state, the collected fibers may be semi-continuous or essentially discontinuous. In certain exemplary embodiments, the melt-blown fibers of the present disclosure may be oriented on a molecular level. The fibers can be interrupted by defects in the melt, crossing of formed filaments, excessive shear due to turbulent air used in attenuating the fibers or other events occurring in the formation process. They are generally understood to be semi-continuous or having the length much longer than the distance between fiber entanglements so that individual fibers cannot be removed from the fiber mass intact end-to-end.

In melt spinning, the non-woven fibers are extruded as filaments out of a set of orifices and allowed to cool and solidify to form fibers. The filaments are passed through an air space, which may contain streams of moving air, to assist in cooling the filaments and passing through an attenuation (i.e., drawing) unit to at least partially draw the filaments. Fibers made through a melt spinning process can be “spunbonded,” whereby a web comprising a set of melt spun fibers are collected as a fibrous web and optionally subjected to one or more bonding operations to fuse the fibers to each other. Melt-spun fibers are generally larger in diameter than melt-blown fibers.

The fibers can be made from a polymer selected from polyolefin, polypropylene, polyethylene, polyester, polyethylene terephthalate, polybutylene terephthalate, polyamide, polyurethane, polybutene, polylactic acid, polyphenylene sulfide, polysulfone, liquid crystalline polymer, polyethylene-co-vinylacetate, polyacrylonitrile, cyclic polyolefin, or copolymer or blend thereof in an amount of at least 35% by weight, based on the overall weight of the plurality of fibers. Suitable fibers materials also include elastomeric polymers.

Non-woven layers based on aliphatic polyester fibers can be especially advantageous in resisting degradation or shrinkage at high temperature applications. Molecular weights for useful aliphatic polyesters can be in the range of from 15,000 g/mol to 6,000,000 g/mol, from 20,000 g/mol to 2,000,000 g/mol, from 40,000 g/mol to 1,000,000 g/mol, or in some embodiments, less than, equal to, or greater than 15,000 g/mol; 20,000; 25,000; 30,000; 35,000; 40,000; 45,000; 50,000; 60,000; 70,000; 80,000; 90,000; 100,000; 200,000; 500,000; 700,000; 1,000,000; 2,000,000; 3,000,000; 4,000,000; 5,000,000; or 6,000,000 g/mol.

The melt-blown or melt-spun fibers of the non-woven fibrous layer can have any suitable diameter. The fibers can have a median diameter of from 0.1 micrometers to 10 micrometers, from 0.3 micrometers to 6 micrometers, from 0.3 micrometers to 3 micrometers, or in some embodiments, less than, equal to, or greater than 0.1 micrometers, 0.2, 0.3, 0.4, 0.5, 0.6, 0.7, 0.8, 0.9, 1, 1.5, 2, 2.5, 3, 3.5, 4, 4.5, 5, 5.5, 6, 6.5, 7, 7.5, 8, 8.5, 9, 9.5, 10, 11, 12, 13, 14, 15, 16, 17, 18, 19, 20, 22, 25, 27, 30, 32, 35, 37, 40, 42, 45, 47, or 50 micrometers.

Optionally, at least some of the plurality of fibers in the non-woven fibrous layer are physically bonded to each other or to the acoustic absorbing filler. Conventional bonding techniques using heat and pressure applied in a point-bonding process or by smooth calendar rolls can be used, though such processes may cause undesired deformation of fibers or compaction of the web. Optionally, attachment between fibers or between fiber and the acoustic absorbing filler may be achieved by incorporating a binder into the non-woven fibrous layer. In some embodiments, the binder is provided by a liquid or a solid powder. In some embodiments, the binder is provided by staple binder fibers, which may be injected into the polymer stream during a melt blowing process. Binder fibers have a melting temperature significantly less than that of remaining structural fibers, and act to secure the fibers to each other. Other techniques for bonding the fibers are taught in, for example, U.S. Patent Publication No. 2008/0038976 (Berrigan et al.) and U.S. Pat. No. 7,279,440 (Berrigan et al.). One technique involves subjecting the collected web of fibers to a controlled heating and quenching operation that includes forcefully passing through the web a gaseous stream heated to a temperature sufficient to soften the fibers sufficiently to cause the fibers to bond together at points of fiber intersection, where the heated stream is applied for a time period too short to wholly melt the fibers, and then immediately forcefully passing through the web a gaseous stream at a temperature at least 50° C. less than the heated stream to quench the fibers.

In some embodiments, two different kinds of molecular phases are present within the fibers. For example, a predominantly semi-crystalline phase may co-exist with a predominantly amorphous phase. As another example, a predominantly semi-crystalline phase may co-exist with a phase containing domains of lower crystalline order (e.g., one in which the polymers are not chain-extended) and domains that are amorphous, the overall degree of order being insufficient for crystallinity. Such fibers can also be processed under heat as above to form a non-woven fibrous laver.

In some embodiments, the fibers of the non-woven fibrous layer do not substantially melt or lose their fiber structure during the bonding operation, but remain as discrete fibers with their original fiber dimensions.

In some embodiments, the fiber polymers display high glass transition temperatures, which can be desirable for use in high temperature applications. Certain non-woven fibrous layers shrink significantly when heated to even moderate temperatures in subsequent processing or use, such as use as a thermal insulation material. Such shrinkage has been shown to be problematic when the melt-blown fibers include thermoplastic polyesters or copolymers thereof, and particularly those that are semi-crystalline in nature.

In some embodiments, the provided non-woven fibrous layers have at least one densified layer adjacent to a layer that is not densified. Either or both of the densified and non-densified layers may be loaded with acoustic absorbing filler. A densified layer can provide a number of potential benefits. If sufficiently dense, such a layer can be disposed on the outermost surface of an acoustic article and act as a barrier to prevent particles of acoustic absorbing filler from escaping from the acoustic article. Densification of the non-woven layer can also enhance structural integrity, provide dimensional stability, and enable the non-woven layer to be molded into a three-dimensional shape. For example, articles based on such structures can be shaped to fit substrates having customized three-dimensional shapes. Customizing the shape of the article or assembly for a particular application optimizes use of space and simplifies attachment to, for example, an automotive or aerospace component. Because these shaped structures are dimensionally stable, these articles also reduce the risk of de-lamination compared with conventional acoustic and thermal insulation products, which have the tendency to spring back to their original, planar configuration.

In some embodiments, the densified layer and adjacent non-densified layer are prepared from a monolithic non-woven fibrous layer initially having a uniform density, which is then subjected to heat and/or pressure to create a densified layer on its outermost surface. Methods of producing a densified layer on a non-woven fibrous web, along with further options and advantages, are described in co-pending International Patent Publication No. WO 2019/051761 (You, et al).

In some embodiments, the densified layer has a uniform distribution of polymeric fibers throughout the layer. Alternatively, the distribution of polymeric fibers can be varied across a major surface of the non-woven fibrous layer. Such a construction may be appropriate where, for example, the acoustic response is to be dependent on its location along the major surface.

In some embodiments, the median fiber diameters of the densified and non-densified portions of the non-woven fibrous layer can be substantially preserved. This can be realized, for example, by way of a process capable of fusing the fibers to each other in the densified region without significant melting of the fibers. Avoidance of melting the fibers can preserve the acoustic benefit that derives from the high surface area produced within the densified layer of the non-woven fibrous layer.

Engineered non-woven fibrous layers can display numerous advantages, some of which are unexpected. These materials can be used in thermal and acoustic insulation applications at high temperatures where conventional insulation materials would thermally degrade or fail. Particularly demanding are automotive and aerospace vehicle applications, where insulation materials operate in environments that are not only noisy but can reach extreme temperatures.

In some embodiments, the non-woven layers can resist shrinkage at temperatures as high as 150° C. or greater, as might be encountered in automotive and aerospace applications. Shrinkage can result from crystallization during heat exposure or processing, and is generally undesirable because it can degrade acoustic performance and impact the structural integrity of the product. Preferably, the non-woven fibrous layers can exhibit a Shrinkage after being heated to 150° C. for 7 days, as measured using the Shrinkage test method described in U.S. Patent Publication No. 2016/0298266 (Zillig et al.), of less than 15%, 14%, 13%, 12%, 11%, 10%, 9%, 8%, 7%, 6%, 5%. 4%, 3%, 2% or 1%. Such Shrinkage values can apply along both the machine and cross-web directions. In some embodiments, disposing acoustic absorbing filler into the interstices of non-woven layer can further reduce the degree of shrinkage at high temperatures.

Yet another advantage relates to the ability to make non-woven fibrous layers that not only operate at high temperatures and are dimensionally stable, but also maintain their overall surface area within both densified and non-densified portions of the web. Retention of the surface area provided by the surface of the fibers (especially those with narrow diameters), in combination with acoustic absorbing filler, allows the material to not suffer from a degradation in performance due to heat-induced instability in the structure of the article. External surface area. i.e. not contained within internal porosity, is relevant because the ability of the non-woven fibrous layer to dissipate noise is based on viscous and thermal dissipation in the space surrounding the fibers surfaces.

When manufacturing non-woven fibrous webs from a single layer, fewer processing and web handling steps are necessary compared with processes used to manufacture articles containing multiple layers. Reducing the number of layers in the end product, while preserving its performance properties, simplifies manufacturing and reduces associated costs.

Other non-woven fibrous layers that may be used in the acoustic article include recycled textile fibers, sometimes referred to as shoddy. Recycled textile fibers, staple fibers, inorganic fibers and natural fibers can be formed into a non-woven structure using an air laid process, in which a wall of air blows fibers onto, for example, a perforated collection drum having negative pressure inside the drum. The air is pulled though the drum and the fibers are collected on the outside of the drum where they are removed as a web. Because of the air turbulence, the fibers are not in any ordered orientation and thus can display strength properties that are relatively uniform in all directions.

Other non-woven fibrous layers that may be used in the acoustic article include those made using a wet laid process. A wet laying or “wetlaid” process comprises (a) forming a dispersion comprising one or more types of fibers, optionally a polymeric binder, and optionally a particle filler(s) in at least one dispersing liquid (preferably water); and (b) removing the dispersing liquid from the dispersion such that the fibers and any filler/binder form a web. Optionally, further processing can be done to bind the wetlaid together, such as heating the web to soften the binder and allow it to fuse the fibers together.

In some embodiments, one or more additional fiber populations are incorporated into the non-woven fibrous layer. Differences between fiber populations can be based on, for example, composition, median fiber diameter, median fiber length, and/or fiber shape.

In some embodiments, a non-woven fibrous layer can include a plurality of first fibers having a median diameter of less than 10 micrometers and a plurality of second fibers having a median diameter of at least 10 micrometers. For various reasons, it can be advantageous to have fibers of different diameters. Inclusion of the thicker second fibers can improve the resiliency of the non-woven fibrous layer, crush resistance, and help preserve the overall loft of the web. The second fibers can be made from any of the polymeric materials previously described with respect to the first fibers and may be made from a melt blown or melt spun process.

The fibers of the non-woven layer can have any suitable fiber diameter to provide desirable mechanical, acoustic, and/or thermal properties. For example, either or both of the first and second fibers can have a median fiber diameter of at least 10 micrometers, from 10 micrometers to 60 micrometers, from 20 micrometers to 40 micrometers, or in some embodiments, less than, equal to, or greater than 10 micrometers, 11, 12, 13, 14, 15, 16, 17, 18, 19, 20, 22, 25, 27, 30, 32, 35, 37, 40, 45, 50, 55, or 60 micrometers.

In some embodiments, the second fibers are staple fibers that are interspersed with the first plurality of the fibers. The staple fibers can include binder fibers and/or structural fibers. Binder fibers include, but are not limited to, any of the above-mentioned polymeric fibers. Suitable structural fibers can include, but are not limited to, any of the above-mentioned polymeric fibers, as well as inorganic fibers such as ceramic fibers, glass fibers, and metal fibers; and biologically-derived fibers such as cellulosic fibers. The blending of staple fibers into the non-woven layer is sometimes referred to as carding.

Additional options and advantages associated with combinations of the first and second fibers are described, for example, in U.S. Pat. No. 8,906,815 (Moore et al.).

Porous layers need not be fibrous in nature. For instance, the one or more porous layers can be a perforated film. Perforated films are comprised of a film having a plurality of perforations, or through-holes, extending therethrough. The perforations allow for the propagation of pressure waves from one side of the film to the opposing side.

Enclosed within the perforations are plugs of air that act as mass components within a resonant system. These mass components vibrate within the perforations and dissipate sound energy from friction between the plugs of air and the walls of the perforations that define the through-holes. If the perforated film is disposed next to an air cavity, dissipation of sound energy may also occur through destructive interference at the entrance of the perforations from any sound waves reflected back towards the perforations from the opposite direction. Absorption of sound energy can take place with essentially zero net flow of fluid through the acoustic article.

The perforations can be provided with dimensions (e.g., perforation diameter, shape and length) suitable to obtain a desired acoustic performance over a given frequency range. Acoustic performance can be measured, for example, by reflecting sound off of the perforated film and characterizing the decrease in acoustic intensity as a result of near-field dampening as compared to the result from a control sample.

In some embodiments, the perforations are disposed along the entire surface of the perforated film. Alternatively, the film could be only partially perforated—that is, perforated in some areas but not others. In certain instances, perforated areas of the film can extend along longitudinal directions and be adjacent to one or more non-perforated areas—for example, the film could have a rectangular cross-section tube with only one or two sides perforated.

The perforations can have a wide range of shapes and sizes and may be produced by any of a variety of molding, cutting or punching operations. The cross-section of the perforations can be, for example, circular, square, or hexagonal. In some embodiments, the perforations are represented by an array of elongated slits. While the perforations may have diameters that are uniform along their length, the perforations can also have the shape of a conical frustum or otherwise have side walls tapered along at least some of their length. Tapering the side walls of the perforations can be advantageous, as described later, in enabling acoustic absorbing filler to be received within the perforations. Various perforation configurations and ways of making the same are described in U.S. Pat. No. 6,617,002 (Wood).

Optionally, the perforations have a generally uniform spacing with respect to each other. If so, the perforations may be arranged in a two-dimensional grid pattern or staggered pattern. The perforations could also be disposed on the film in a randomized configuration where the exact spacing between neighboring perforations is non-uniform but the perforations are nonetheless evenly distributed across the film on a macroscopic scale.

In some embodiments, the perforations are of essentially uniform diameter along the film. Alternatively, the perforations could have some distribution of diameters. In either case, the average narrowest diameter of the perforations can be less than, equal to, or greater than 10 micrometers, 15, 20, 25, 30, 35, 40, 45, 50, 60, 70, 80, 90, 100, 110, 120, 150, 170, 200, 250, 300, 350, 400, 450, 500, 600, 700, 800, 900, 1000, 1500, 2000, 2500, 3000, 4000, or 5000 micrometers. For clarity, the diameter of non-circular holes is defined herein as the diameter of a circle having the equivalent area as the non-circular hole in plan view.

Compared to other porous layers, perforated films can be made relatively thin while retaining their acoustic absorption properties. Perforated films can have an overall thickness of from 1 micrometer to 2 millimeters, from 30 micrometers to 1.5 millimeters, from 50 micrometers to 1 millimeter, or in some embodiments, less than, equal to, or greater than, 1 micrometer, 2, 5, 10, 20, 30, 40, 50, 100, 200, 500, 700 micrometers, 1 millimeter, 1.1, 1.2, 1.5, 1.7, or 2 millimeters. In some embodiments, a perforated slab is used instead of a perforated film, where the perforated slab has a thickness of up to 3 millimeters, 5, 10, 30, 50, 100, or even 200 millimeters. The porosity of the perforated film is a dimensionless quantity representing the fraction of a given volume not occupied by the film. In a simplified representation, the perforations can be assumed to be cylindrical, in which case porosity is well-approximated by the percentage of the surface area of the film displaced by the perforations in plan view. In exemplary embodiments, the film can have a porosity of 0.1% to 10%, 0.5% to 10%, or 0.5% to 5%. In some embodiments, the film has a porosity less than, equal to, or greater than 0.1%, 0.2, 0.3, 0.4, 0.5, 0.7, 1, 2, 3, 4, 5, 6, 7, 8, 9, or 10%.

The film material can have a modulus (e.g., flexural modulus) suitably tuned to vibrate in response to incident sound waves having relevant frequencies. Along with the vibrations of the air plugs within the perforations, local vibrations of the film itself can dissipate sound energy and enhance transmission loss through the acoustic article. The flexural modulus, reflecting the stiffness, of the film also directly affects its acoustic transfer impedance.

In some embodiments, the film comprises a material having a flexural modulus of from 0.2 GPa to 10 GPa, 0.2 GPa to 7 GPa, 0.2 GPa to 4 GPa, or in some embodiments, less than, equal to, or greater than a flexural modulus of 0.2 GPa, 0.3, 0.4, 0.5, 0.7, 1, 2, 3, 4, 5, 6, 7, 8, 9, 10, 12, 15, 17, 20, 25, 30, 35, 40, 50, 60, 70, 80, 90, 100, 120, 140, 160, 180, 200, or 210 GPa.

Suitable thermoplastic polymers typically have a flexural modulus in the range of from 0.2 GPa to 5 GPa. Addition of fibers or other fillers can, in some embodiments, increase the flexural modulus of these materials to 20 GPa. Thermoset polymers generally have a flexural modulus in the range of from 5 GPa to 40 GPa. Useful polymers include polyolefins, polyesters, fluoropolymers, polylactic acid, polyphenylene sulfide, polyacrylates, polyvinylchloride, polycarbonates, polyurethanes, and blends thereof.

Acoustic performance characteristics that can be ascribed to a plurality of perforations disposed in a flexible film are described in, for example, U.S. Pat. No. 6,617,002 (Wood), U.S. Pat. No. 6,977,109 (Wood), and U.S. Pat. No. 7,731,878 (Wood). Acoustic filler particles can be loaded into the perforations of the film to enhance the overall properties of the film, including acoustic absorption properties.

In some embodiments, the porous layer includes a particle bed. The particle bed may contain non-porous materials, such as milled polymer granules, glass beads, or ceramic materials, or porous materials, such as clays, perlite, or granules of biomass. Some, or all, of the particles of the particle bed may be acoustic absorbing filler that is acoustically active. The porosity of the particle bed can be adjusted in part based on the size distribution of the particles. The particles may be in a range of from 100 micrometers to 2000 micrometers, from 5 micrometers to 1000 micrometers, from 10 micrometers to 500 micrometers, or in some embodiments, less than, equal to, or greater than, 0.1 micrometers, 0.5, 1, 2, 5, 10, 20, 30, 40, 50, 70, 100, 200, 300, 400, 500, 700, 1000, 1500, or 2000 micrometers. In some embodiments, the particles in the particle bed may be in a range of from 100 micrometers to 710 micrometers.

A porous layer can be generally characterized by its specific acoustic impedance, which is the ratio in frequency space of pressure differences across the layer and the effective velocity approaching the layer surface. In the theoretical model based on a rigid film with perforations, for example, the velocity derives from air moving into and out of the perforations. If the film is flexible, motion of the film can contribute to the acoustic impedance calculation. Specific acoustic impedance generally varies as a function of frequency and is a complex number, which reflects the fact that pressure and velocity waves can be out of phase with each other.

As used herein, specific acoustic impedance is measured in MKS Rayls, in which 1 MKS Ray1 is equal to 1 pascal-second per meter (Pa·s·m⁻¹), or equivalently, 1 newton-second per cubic meter (N·s·m³), or alternatively, 1 kg·s⁻¹·m².

A porous layer can also be characterized by its transfer impedance. For a perforated film, transfer impedance is the difference between the acoustic impedance on the incident side of the porous layer and the acoustic impedance one would observe if the perforated film were not present—that is, the acoustic impedance of the air cavity alone.

The flow resistance is the low frequency limit of the transfer impedance. Experimentally, this can be estimated by blowing a known, small velocity of air at the porous layer and measuring the pressure drop associated therewith. The flow resistance can be determined as the measured pressure drop divided by the velocity.

For embodiments that include a perforated film, the flow resistance through the perforated film alone (absent the acoustic absorbing filler) can be from 40 MKS Rayls to 8000 MKS Rayls, 100 MKS Rayls to 4000 MKS Rayls, or 400 MKS Rayls to 3000 MKS Rayls. In some embodiments, the flow resistance through the perforated film can be less than, equal to, or greater than 40 MKS Rayls, 50, 60, 70, 80, 90, 100, 120, 140, 160, 180, 200, 250, 300, 350, 400, 450, 500, 550, 600, 650, 700, 750, 800, 850, 900, 950, 1000, 1100, 1200, 1300, 1400, 1500, 1600, 1700, 1800, 1900, 2000, 2500, 3000, 3500, 4000, 4500, 5000, 5500, 6000, 6500, 7000, 7500, or 8000 MKS Rayls.

For embodiments that include a non-woven fibrous layer, the flow resistance through the non-woven fibrous layer alone (absent the acoustic absorbing filler) can be from 50 MKS Rayls to 8000 MKS Rayls, 100 MKS Rayls to 4000 MKS Rayls, or 400 MKS Rayls to 3000 MKS Rayls. In some embodiments, the flow resistance through the non-woven fibrous layer can be less than, equal to, or greater than 50 MKS Rayls, 60, 70, 80, 90, 100, 120, 140, 160, 180, 200, 250, 300, 350, 400, 450, 500, 550, 600, 650, 700, 750, 800, 850, 900, 950, 1000, 1100, 1200, 1300, 1400, 1500, 1600, 1700, 1800, 1900, 2000, 2500, 3000, 3500, 4000, 4500, 5000, 5500, 6000, 6500, 7000, 7500, or 8000 MKS Rayls.

The flow resistance through the overall acoustic article can be from 40 MKS Rayls to 10,000 MKS Rayls, from 1000 MKS Rayls to 10,000 MKS Rayls, or from 2500 MKS Rayls to 7000 MKS Rayls. In some embodiments, the flow resistance through the overall acoustic article is less than, equal to, or greater than 40 MKS Rayls, 1000 1100, 1200, 1500, 1700, 2000, 2500, 3000, 3500, 4000, 4500, 5000, 5500, 6000, 6500, 7000, 7500, 8000, 9000 or 10,000 MKS Rayls.

### Acoustic Article

The acoustic absorbing filler may be embedded in the porous layer according to a variety of configurations. Where the porous layer is a non-woven fibrous layer, open-celled foam, or particle bed, for example, the acoustic absorbing filler may be dispersed within the non-woven fibrous layer, open-celled foam, or particle bed. Where the porous layer includes a perforated film, the acoustic absorbing filler may reside, at least in part, within the plurality of perforations extending through the perforated film. In some embodiments, at least 5%, at least 10%, at least 20%, at least 30%, at least 40%, at least 50%, at least 60%, at least 70%, at least 80%, at least 90%, or at least 95% of the acoustic absorbing filler contacting the porous layer resides within the plurality of apertures.

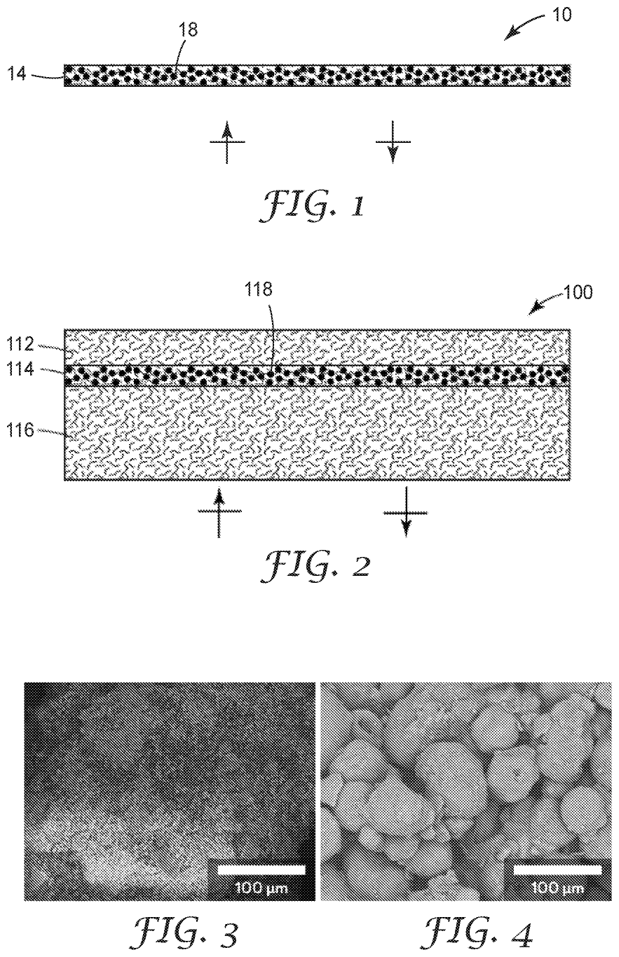

An acoustic article according to one exemplary embodiment is illustrated in FIG. 1. The acoustic article 10 comprises a porous layer 14 and acoustic absorbing filler 18 embedded in the porous layer. Although the porous layer 14 in FIG. 1 is a nonwoven layer, it should be understood that the porous layer is not particularly limited and could be a packed bed made partially or entirely of the acoustic absorbing filler or a perforated film having a plurality of perforations in which the acoustic absorbing filler resides in at least a portion of the plurality of perforations. The direction of incident and reflected sound waves are represented by barred arrows, where applicable.

In a second embodiment illustrated in FIG. 2, the acoustic article 100 is comprised of three primary layers. The layers include, in the following order, a first porous layer 112, a second porous layer 114, and a third porous layer 116. Optionally and as shown, the porous layers 112, 114 and porous layers 114, 116 directly contact each other. In some embodiments, one or more additional layers can be disposed between these layers or extend along the exterior facing major surfaces of porous layers 112, 116. Alternatively, one or both of porous layers 112, 116 could be omitted.

In the article 100, the porous layers 112, 114, 116 are depicted as fibrous non-woven layers, but it is to be understood that other kinds of porous layers (e.g., particle beds, and perforated films) may be used instead. As indicated in FIG. 2, the second porous layer 114 contains acoustic absorbing filler, while the porous layers 112, 116 are substantially devoid of acoustic absorbing filler.

The acoustic absorbing filler 118 can be present in an amount of from 1% to 99%, 10% to 90%, 15% to 85%, 20% to 80%, or in some embodiments, less than, equal to, or greater than 1%, 2, 3, 4, 5, 7, 10, 12, 15, 20, 25, 30, 35, 40, 45, 50, 55, 60, 65, 70, 75, 80, 85, 90, 95, 97, 98, or 99% by weight relative to the overall weight of the second porous layer 114 and acoustic absorbing filler contacting the second porous layer 114.

Optionally, but not shown, the acoustic absorbing filler may be only partially embedded in the second porous layer 114, with some acoustic absorbing filler residing outside of the second porous layer 114.

Advantageously, the addition of acoustic absorbing filler comprised of porous particles can substantially increase the normal incidence acoustic absorption of the acoustic article at low sound frequencies, such as sound frequencies of from 50 Hz to 1000 Hz. In some embodiments, the acoustic article has a normal incidence acoustic absorption of no less than 0.09 alpha, 0.1, 0.2, or 0.3 alpha at 400 Hz. In some embodiments where the porous layer of the acoustic article is a nonwoven fibrous layer, the acoustic article has a normal incidence acoustic absorption of no less than 0.1 alpha at 400 Hz. In some embodiments where the porous layer of the acoustic article is a packed bed, the acoustic article has a normal incidence acoustic absorption of no less than 0.2 alpha at 400 Hz.

Further, the addition of acoustic absorbing filler comprised of porous particles can increase the normal incidence acoustic absorption of the acoustic article at intermediate to high frequencies (1000 Hz to 10,000 Hz) such that alpha exceeds 0.3, 0.4, 0.5, 0.6, 0.7, 0.8 or 0.9 in a random incident acoustic measurement (e.g., alpha cabin test) at frequencies from 2000 to 10000 Hz.

In some embodiments, the addition of acoustic absorbing filler can increase acoustical absorption of the acoustic article over sound frequencies of less than, equal to, or greater than 50 Hz, 55, 60, 65, 70, 75, 80, 85, 90, 95, 100, 105, 110, 115, 120, 125, 130, 135, 140, 145, 150, 155, 160, 165, 170, 175, 180, 185, 190, 195, 200, 210, 220, 230, 240, 250, 260, 270, 280, 290, 300, 400, 500, 700, 1000, 2000, 3000, 4000, 5000, 7000, or 10,000 Hz.

In the depicted embodiment, the third porous layer 116 has a thickness significantly greater than that of the first porous layer 112.

In these constructions, one porous layer may have a thickness that is less than, equal to, or greater than 10%, 20%, 30%, 40%, 50%, 60%, 70%, 80%, 90%, 100%, 110%, 120%, 130%, 140%, 150%, 200%, 250%, 300%, 400%, 500%, 600%, 700%, 800%, 900%, or 1000% of the thickness of the other porous layer.

The provided acoustic articles preferably have an overall thickness that achieves the desired acoustic performance within the space constraints of the application at hand. An individual porous layer can have an overall thickness of from 1 micrometer to 10 centimeters, from 30 micrometers to 1 centimeter, from 50 micrometers to 5000 millimeters, or in some embodiments, less than, equal to, or greater than, 1 micrometers, 2, 5, 10, 20, 30, 40, 50, 100, 200, 500 micrometers, 1 millimeter, 2, 3, 4, 5, 7, 10, 20, 50, 70, or 100 millimeters.

The porous layer 116 can serve as resistive materials that improve the low frequency performance of the total acoustic article. The porous layer 116 can also reduce acoustic particle velocity (referring to the air molecules), which tends to induce reflection of the sound wave upon reaching the porous layer 114. Reflection tends to occur in this scenario because the acoustic impedance (pressure/velocity) becomes very high as velocity approaches zero. The presence of acoustic absorbing filler, however, can act as a pressure-reducing layer induced by reversible adsorption/desorption of air molecules as described previously, or by other mechanisms such as diffusive transport of air molecules into the pore network. Reducing pressure also lowers acoustic impedance, enabling some sound to penetrate and helping entrap more sound energy within the acoustic article 100, thereby improving acoustic performance.

In this embodiment, the acoustic absorbing filler is substantially decoupled from each other and any porous layers: that is, the agglomerates of the acoustic absorbing filler are not physically attached to each other and capable of at least limited movement or oscillation independently from the surrounding structure. In these instances, the embedded acoustic absorbing filler can move and vibrate within the fibers of the non-woven material largely independently of the fibers themselves.

Alternatively, at least some of the acoustic absorbing filler could be physically bonded to the porous layers in which it is disposed. In some embodiments, these physical bonds are created by incorporating binders (e.g., binder fibers) within the porous layer, which can become tacky and adhere to the acoustic absorbing filler upon application of heat. To preserve the acoustic properties of the acoustic absorbing filler, it is generally preferable that the binder does not significantly flow into the pores of the porous particles. In some embodiments, it is possible to use the binder of the acoustic absorbing filler as means for physical bonding to the porous layer.

The acoustic articles of the present disclosure can be applied to a variety of substrates, including the structural components of automobiles, airplanes or buildings. Substrates include molded panels (e.g., door panels), aircraft frames, in-wall insulation, and integral ductwork. Substrates can also include components next to these structural examples, such as carpets, trunk liners, fender liners, front of dash, floor systems, wall panels, and duct insulation. In some cases, a substrate can be spaced apart from the acoustic article, as might be the case with hood liners, headliners, aircraft panels, drapes, and ceiling tiles. Further applications for these materials include filtration media, surgical drapes, wipes, liquid and gas filters, garments, blankets, furniture, transportation (e.g., for aircraft, rotorcraft, trains, and automotive vehicles), wheeled or tracked vehicles for agricultural applications (e.g. tractors, combines), wheeled or tracked vehicles for industrial applications (e.g. excavators, bulldozers, mobile drilling equipment), electronic equipment (e.g. for televisions, computers, servers, data storage devices, and power supplies), air handling systems, upholstery, and personal protection equipment.

### Methods of Manufacture

The provided acoustic articles can be assembled using any of a number of suitable manufacturing methods.

Acoustic absorbing filler can be formed by spray drying to form agglomerates of the porous particles and the binder. In some embodiments, the binder solution can be sprayed onto the spray-dried porous particles in a vessel undergoing low shear or high shear agitation, or in a fluidized bed of the spray dried porous particles. Larger agglomerates form during the course of these processes and partially dry during the processing, and the resultant fillers can have sufficient green body strength for handling. In other embodiments, no additional agglomeration steps are needed after the production of the initial spray-dried particles. Further treatments, such as thermal treatments or exposure to radiation, can be done to further improve filler robustness.

In some embodiments, the porous particles and binder can be agitated in a fluidized bed. While the mixture is agitated, additional binder, a solution/suspension containing the binder, or water can be sprayed onto the particles. Agglomerates form and dry during this process, which imparts a green strength to the filler that allows for handling.

In some embodiments, binder components and porous particles can be combined by dry mixing or via mixing in a bed with a fluid present to prevent dust cloud formation. This mixture can then be agitated under low or high shear as a binder, a binder-containing solution/suspension, or water is sprayed into the mixture. Agglomerates form during the course of these processes and at least partially dry during the processing, and the resultant fillers can have sufficient green body strength for handling. Oversize filler can also be crushed and classified to produce smaller filler that is within a specified size range. Further treatments, such as thermal treatments or exposure to radiation, can be done to further improve filler robustness.

In some embodiments, binder and porous particles can be combined by dry mixing or wet mixing followed by heating to dry off the liquid (if present). The heating activates the binder, allowing it to soften and fuse the mixture into a composite block upon cooling. This block can then be crushed to form smaller agglomerates.

For embodiments in which the porous layer is a non-woven fibrous web, acoustic absorbing filler can be embedded into the constituent fibers either during or after the direct formation of the fibers. Where the non-woven fibrous web is made using a melt blowing process, for example, the acoustic absorbing filler may be conveyed and co-mingled with the streams of molten polymer as they are blown onto a rotating collector drum. The acoustic absorbing filler may be entrained within a flow of heated air that converges with the hot air used to attenuate the melt blown fibers. An exemplary process is described in U.S. Pat. No. 3,971,373 (Braun). In a similar fashion, particles of acoustic absorbing filler can be conveyed into an air laid process, such as the process use to manufacture porous layers made from recycled textile fibers (i.e., shoddy).

Acoustic absorbing filler can also be added after the non-woven fibrous layer has been made. For example, the porosity of the non-woven fibrous layer could enable the acoustic absorbing filler to infiltrate into its interstitial spaces by homogeneously dispersing the acoustic absorbing filler into a liquid medium such as water, followed by roll coating or slurry coating the particle-filled medium onto the non-woven porous layer. As an alternative to using a liquid medium, one can entrain the acoustic absorbing filler in a gaseous stream, such as an air stream, and then direct the stream toward the non-woven layer to fill it.

Alternatively, acoustic absorbing filler can also be embedded into the porous layer by agitation. In one embodiment of this method, a non-woven fibrous layer is placed over a flat surface and a conduit placed over it to define a coating area. Particles of the acoustic absorbing filler can then be poured into the conduit and the assembly agitated until the particles are fully migrated into the non-woven structure through its open pores. A similar method may be used for porous layers comprised of open-celled foams.

Construction of multilayered acoustic articles and attachment to substrates can include one or more lamination steps. Lamination may be achieved using an adhesive bond. Preferably, any adhesive layers used do not interfere with sound penetration into the absorbing layer. Alternatively, or in combination, physical entanglement of fibers may be used to improve interlayer adhesion. Mechanical bonds, using fasteners for example, are also possible.

The acoustic articles can also be edge sealed to prevent particle egress. Such containment can be achieved by densifying the edges, filling edges with a resin, quilting the acoustic article, or fully encasing the acoustic article in a sleeve to prevent particle movement or egress. Edge sealing can be desirable to improve product lifetime, durability, and facilitate handling and mounting. Edge sealing can also be performed for aesthetic reasons.

In yet another embodiment, a non-woven fibrous layer can be sequentially sprayed with an adhesive and then with the filler particles. In some instances, the adhesive may be provided in the form of hot melt fibers.

### EXAMPLES

These examples are merely for illustrative purposes only and are not meant to be limiting on the scope of the appended claims. Unless otherwise noted or readily apparent from the context, all parts, percentages, ratios, etc. in the Examples and the rest of the specification are by weight.

The following abbreviations are used in this section: in=inches, μm=micrometers, mm=millimeters, cm=centimeters, m=meters, g=grams, ° C.=degrees Celsius, K=degrees Kelvin, cc=cubic centimeter, mL=milliLiter, mTorr=milliTorr, psi=pounds per square inch, Pa=Pascals, GSM=grams per square meter, BMF=blown microfiber, sec=seconds, min=minutes, Hz=Hertz, lb=pounds, wt %=weight percent, vol %=volume percent, rpm=revolutions per minute, lpm=Liters per minute. Abbreviations for materials used in this section, as well as descriptions of the materials, are provided in Table 1.

TABLE 1
Materials Used in the Examples

| Abbrevi- | |
|---|---|
| ation | Description and Source |
| RESIN A | Polypropylene metallocene homopolymer resin available |
| | under the designation METOCENE MF650Y from |
| | LyondellBasell Industries, Houston, TX |
| RESIN B | Film-grade polypropylene resin, available under the |
| | designation C700-35N from Braskem, São Paulo, Brazil |
| RESIN C | Carbon black-loaded polypropylene masterbatch obtained |
| | under the trade designation PP 3019 BK MB from |
| | RTP Company, Winona, MN |
| RESIN D | Red-pigmented anti-static polypropylene masterbatch |
| | obtained under the trade designation |
| | 199 X 141358 SS-57495 MB from RTP Company |
| MILLING | Yttria-stabilized zirconia spherical milling media |
| MEDIA | obtained under the trade designation TORAYCERAM |
| | BEADS from Toray Industries, Inc. Tokyo, Japan |
| BINDER A | Polyacrylate binder available under the trade |
| | designation RHOPLEX VSR-50 from Dow Inc., |
| | Midland, MI |
| BINDER B | Powdered, natural kaolin clay available under the |
| | trade designation ACTI-MIN RP-2 from Active |
| | Minerals International, LLC. Sparks, MD |
| PARTICLE | Type B silica gel available under the trade |
| A | designation PREMIUM QUALITY TYPE B SILICA GEL |
| | from Wisesorbent, Technologies, Marlton, NJ |
| PARTICLE | Type A silica gel available under the trade |
| B | designation AW0210G from Interra Global Corp., |
| | Park Ridge, IL |
| PARTICLE | Aggregated fumed silica with surface area of ~300 m²/ |
| C | g by N₂ sorption and BET analysis available |
| | under the trade designation AEROPERL 300/30 from |
| | Evonik Industries AG, Essen, Germany |
| PARTICLE | PJAC steam-activated coconut shell carbon granules sieved |
| D | between 40 and 140 US mesh size, available under the |
| | trade designation PJ40140-233TM from Philippine-Japan |
| | Active Carbon Corporation., Davao City, Philippines |

### Test Methods

### Method for Bulk Density

Bulk densities were measured following ASTM D2854-09, with the exception that the graduated cylinder was filled to 40 percent or greater of its capacity with the measured specimen.

### Method for Skeletal Density I

Skeletal densities for EX-1 through EX-6 and CE-1 through CE-3 were measured following ASTM D5550-14, with the exception that the grinding step described in 10.2 was omitted because the particles were already similar in size to sand. Moisture removal was performed in a moisture analyzer (obtained under the trade name PMC 110 from Radwag USA L.L.C. North Miami Beach, FL) at 110° C. until equilibrium was reached. For the pycnometry, a helium gas Micromeritics Accupyc II 1340 TEC pycnometer (Micromeritics, Norcross, GA) was used. Prior to obtaining measurements, the instrument was calibrated for measured volume using a metal ball of a specified, traceable volume. A 3.5 mL cup was used for the measurements, and measurements were taken at ambient temperature.

### Method for Skeletal Density II

Skeletal density for CE-4 was measured following ASTM D2638-10, wherein the sample was ground in a jar mill containing deionized water and coarse alumina milling media for 24 hours. After milling, the material was dried. For D2638-10, moisture was removed for 42 hours at 150° C. in a convection oven. For the pycnometry, a helium pycnometer (obtained under the trade designation “ACCUPYC 1340 II TEC” from Micromeritics, Norcross, GA) was used. Prior to obtaining measurements, the instrument was calibrated for measured volume using a metal ball of a specified, traceable volume. A 3.5 mL cup was used for the measurements and measurements were taken at ambient temperature.

### Method for Gas Sorption

Materials were analyzed using an Autosorb IQ₂-MP (Anton Paar QuantaTec Inc., Boynton Beach, FL) gas sorption analyzer. Specimens from agglomerates were loaded into 9 mm diameter sample tubes and all agglomerates were outgassed at <100 mTorr for at least 12 hours at 75° C. The unmodified or hammer-milled silica gel samples were outgassed at <100 mTorr for at least 5 hours at 200° C. Finally, the carbon comparative was outgassed at <100 m Torr for at least 12 hours at 150° C. Helium was used for the void volume determination, which was performed periodically during the measurement. Isotherms were measured using nitrogen gas at 77 K. Application of the multi-point Brunauer-Emmett-Teller (MBET) equation was performed on the adsorption branch using points from 0.05 to 0.35 P/Po for silica-containing samples and 0.02 to 0.1 P/Po for samples containing Particle D. Total pore volume was calculated using a point on the adsorption branch taken at ˜0.995 P/Po.

Equilibrium non-local density functional theory (NLDFT) analysis using a kernel with silica as the adsorbent, nitrogen at 77 K as the adsorbate, and cylindrical pore geometry. For the activated carbon, equilibrium quenched state density functional theory (QSDFT) analysis using a kernel with carbon as the adsorbent, nitrogen at 77 K as the adsorbate, and a slit-like pore geometry. These analyses also allowed for the determination of pore volume and surface area in a specified range, i.e. the micropore size range or the mesopore size range. Because the cumulative surface area and pore volume was tabulated by the software (ASiQwin from Anton Parr Quanta Tec Inc.) from the DFT fitting, the aforementioned determinations were made by selecting the relevant pore size bins to calculate the amount of pore volume and surface area in a specific pore size range.

### Method for Scanning Electron Microscopy

Materials (EX-2 and EX-4, as described below) were sprinkled on double-sided carbon tape that was affixed to an aluminum sample stub. These specimens were sputter coated with material from a Pd—Au target. The specimens were analyzed using a Hitachi TM3000 tabletop scanning electron microscope (Hitachi High Technologies, Inc., Tokyo, Japan) using analysis mode for the voltage/current setting. The SEM images of EX-2 and EX-4 are provided in FIGS. 3 and 4, respectively.

### Method for Filler Loading (wt %)

For articles comprising one web, filler loading (wt %) was calculated as the ratio of the difference between the total web basis weight and the base web basis weight to the total web basis weight, multiplied by 100%. For example, if the base web basis weight was 400 GSM and the total basis weight was 600 GSM, the filler loading (wt %) would be calculated as: (600 GSM-400 GSM)/600 GSM×100%=33.3%.

### Method for Filler Loading (Vol %)

Filler volume loading (%) was calculated based on Equation 1. Particle density is taken to be the skeletal density.

$$Filler Volume Loading ( \% ) = \frac{particle volume}{sample volume} \times 100 = ( \frac{weight fraction of particles \times web weight ( g )}{\frac{particle density ( g / {m}^{3} )}{web thickness ( m ) \times web area ( {m}^{2} )}} ) \times 100 \qquad ( 1 )$$

### Method for Fiber Solidity

Fiber solidity was calculated based on Equation 2. Polymer density for polypropylene is 0.91 g/mL.

$$Filler Solidity ( \% ) = \frac{fiber volume}{sample volume} \times 100 = ( \frac{fiber weight ( g )}{\frac{fiber polymer density ( g / {m}^{3} )}{web thickness ( m ) \times web area ( {m}^{2} )}} ) \times 100 \qquad ( 1 )$$

### Method for Nonwoven Thickness 1

The sample thickness of a 5.25 in (13.34 cm) disc was measured using a thickness testing gauge having a tester foot with dimensions of 5 cm×12.5 cm at an applied pressure of 150 Pa.

### Method for Nonwoven Thickness 2

The sample thickness of strips with dimensions of 1.2 m×0.2 m was measured using a thickness tester (obtained under the trade designation “GUSTIN-BACON MEASURE-MATIC” from CERTAINTEED, Malvern, PA) having an attached analog dial indicator. A 130.14 g weight was used to give an applied pressure of 2 Psi (14 kPa). For a given material, two strips were measured. For each of the strips, the thickness of the two ends (lengthwise) were measured and the values were averaged. The measurements from each of the two strips were then averaged to provide the reported value.

### Method for Pressure Drop

A high-speed automated filter tester (obtained under the trade designation “8130” from TSI Inc., Shoreview, MN) was operated with particle generation and measurement turned off. Flowrate was adjusted to 85 liters per minute (LPM) and a 5.25 in (13.34 cm) diameter sample was used. The sample was placed onto the lower circular plenum opening and the tester was engaged. A pressure transducer (obtained from MKS Instruments, Inc., Andover, MA) within the device measured the pressure drop in mm H₂O.

### Method for Airflow Resistance (AFR)

AFR was measured from a 47 mm disk using a 44.44 mm holder according to ASTM C-522-03 (Reapproved 2009), “Standard Test Method for Airflow Resistance of Acoustical Materials”. The instrument used was a “static airflow resistance meter” (obtained under the trade designation “SIGMA” running “SIGMA-X” software from Mecanum, Sherbrooke, Canada). Results are reported in units of MKS Rayls.

For the microperforated film samples the results of the Method for AFR for the Preparative Examples are listed. AFR measurements were not performed with the loaded films, since the filler particles were so lightweight they would potentially be dislodged from the films during the test. Method for AFR was instead conducted with similarly sized but higher density spherical zirconia particles MILLING MEDIA. AFR values for those materials should be comparable based on acoustic theory.

### Effective Fiber Diameter (EFD)

EFD is the apparent diameter of the fibers in a fiber web made without fillers, calculated from a Pressure Drop measured as described above for “Method for Pressure Drop,” a thickness measured as described above for “Method for Nonwoven Thickness 1,” and face velocity 5.3 cm/sec. Based on the measured pressure drop, the EFD in μm was calculated as set forth in C.N. Davies, The Separation of Airborne Dust and Particulates, Institution of Mechanical Engineers, London Proceedings, IB (1952).

### Method for Normal Incident Acoustical Absorption

A kit (obtained under the trade designation “IMPEDANCE TUBE KIT (50 HZ-6.4 KHZ) TYPE 4206” from Brüel & Kjær. Nærum, Denmark) was used. Normal incident acoustical absorption was tested according to ASTM E1050-12, “Standard Test Method for Impedance and Absorption of Acoustical Materials Using a Tube, Two Microphones and a Digital Frequency Analysis System” with the modifications specified below. The impedance tube was 63 mm in diameter and oriented vertically, with the microphones above the sample chamber. The normal incident absorption coefficient was reported with respect to one third octave band frequency using the abbreviation “α.” For the acoustic filler, the sample chamber in the tube was filled to a depth of 20 mm for all measurements unless specified, and the added material was weighed after the test to determine the GSM-normalized absorption. For loaded film samples, the samples were tested as 68-mm discs and placed directly over a 68-mm metal screen resting on the lip of the sample chamber set to a 20-mm gap height.

### Method for Random Incidence Acoustical Absorption via Reverberation

Example articles containing BMF or fillers and BMF were tested for sound absorption according to SAE J2883 “Laboratory Measurement of Random Incidence Sound Absorption Tests Using a Small Reverberation Room”. The reverberation room used was available under the trade designation “ALPHA CABIN” and obtained from Autoneum, Winterthur, Switzerland. In the test, 1.20 m² of material was used in a 10 mm, 15 mm or 30 mm frame at 22° C. and 55-56% humidity. Samples were re-lofted overnight by keeping them unrolled and lying flat on a table, unless otherwise noted. Unless otherwise noted, webs were tested with the side that had been facing the collector drum, when made, facing upward in the ALPHA CABIN.

### Preparatory Examples 1-3 (PE-1 Through PE-3): Preparation of Milled Porous Silica and Granular Activated Carbon

Preparatory Examples 1 and 2 (PE-1 and PE-2): PARTICLE A was placed in a plastic-lined jar filled with coarse alumina milling media (the media filled the jar roughly ⅓^{rd} full). The ratio of water to PARTICLE A was kept between 3:1 and 4:1. This mixture was milled on a roller mill for at least 24 hours. Recovered slurry was dried at 70 to 120° C. for 16 to 24 hours to obtain fine, milled powder. Any caked powder was gently broken up by hand prior to further use. The resulting powder was collected as PE-1. The same procedure was followed with PARTICLE B and this powder was collected as PE-2.

Preparatory Example 3 (PE-3): PARTICLE D was classified using wire mesh screens having 90, 212, 310, and 425-μm openings in a 60 inch (152.4 cm) diameter round vibratory screener (SWECO, Florence, KY). The screening rate of the material in the separator was adjusted using eccentric weights on the motion generator shaft to 1 lb/min (2.2 kg/min). The fraction between 212 and 310 μm was collected as PE-3.

### Preparatory Examples 4 and 5 (PE-4 and PE-5): Preparation of Perforated Films

Microperforated films were prepared as described in U.S. Pat. No. 6,617,002 (Wood). For PE-4, RESIN B with RESIN C added at 3 wt % was extruded in a film of 1.5 mm thickness. For PE-5, RESIN B with RESIN D added was extruded in a film of 0.52 mm thickness. The films were embossed, and heat treated so that the embossing created perforations with different-sized rectangular shaped openings as viewed from the top, where the two principal dimensions measured on the top surface were designated Lₜ (length) and Wₜ (width), and the two principal dimensions measured on the bottom surface were designated L_{b} (length) and W_{b} (width). The cross section of the perforations as viewed from both the long and short directions was trapezoidal. The dimensions of the perforations, recorded as average values in μm, are listed in Table 2.

TABLE 2
Microperforated Film Aperture Dimensions

| | Lₜ | L_{b} | Wₜ | W_{b} | Thickness | Hole Density |
|---|---|---|---|---|---|---|
| | (μm) | (μm) | (μm) | (μm) | (μm) | (holes/cm²) |
| PE-4 | 1900 | 300 | 600 | 260 | 1500 | 65 |
| PE-5 | 600 | 130 | 200 | 80 | 520 | 630 |

### Examples 1-5 (EX-1 Through EX-5): Synthesis of Agglomerated Filler

EX-1 through EX-5 were prepared by the following procedure. Silica material (PE-1, PE-2, or PARTICLE C), DI (de-ionized) water, BINDER A and BINDER B were combined in amounts indicated in Table 3. Materials were mixed in a KitchenAid KFC3511GA food processor (Whirlpool Corporation, Benton Charter Township, MI). During addition of the binder and water suspension, the material was periodically broken up using a spatula to ensure uniform distribution of the binder. After mixing, the agglomerates were heated at 50° C. overnight for drying. For EX-1, EX-2, EX-4, and EX-5, the material was recovered after drying, collapsed into powder, and was reagglomerated using the amount of water indicated in Table 3. Drying was conducted at 50° C. overnight and the resultant particle were sufficiently robust to be handled. Dried agglomerates were classified using two sieves with wire mesh screens (Retsch GmbH, Haan, Germany), the first with 710-μm openings and second with 100-μm openings. These sieves were placed into a Retsch AS 200 sieve shaker, and they were agitated at a setting of 1 mm (half-amplitude) for 10 minutes. Any agglomerated material that passed through the 710-μm screen and was blocked by the 100-μm screen was used.

### Example 6 (EX-6): Synthesis of Agglomerated Filler Through High Shear Mixing

EX-6 was prepared by the following procedure. The engineered silica-clay composite particle was prepared using an EIRICH Intensive mixer (Maschinenfabrik Gustav Eirich GmbH & Co KG, Hardheim, DE) and the amounts as indicated in Table 3. Initially, the BINDER B and PE-1 were added to the mixing pan and dry mixed at a low rotation speed. Once mixed, the diluted BINDER A suspension was added via a port above the mixing pan at a setting of 15 RPM for both the pan and mixing head. Then, the mixture was mixed for 5 min at 60 rpm for rotor and pan motor speed. The mixture was stirred and re-mixed for 5 min at 60 rpm for rotor and pan motor speed but with counter-clockwise for rotor direction. The obtained sample was dried in shallow aluminum trays in an oven at 70° C. for 24 hours. This dried material was recovered and remixed with a portion of water indicated in Table 3. The filler was then dried in shallow aluminum trays in an oven at 70° C. for 24 hours.

### Comparative Examples 1-4 (CE-1 Through CE-4)

Comparative Examples 1 and 2 (CE-1 and CE-2): PARTICLE A was first hammermilled using an IKA MF 10 mill with a MF 10.1 cutting-grinding head and a 1.0 mm sieve (IKA Works, Inc., 2635 Northchase Parkway SE, Wilmington, NC). It was then classified using two sieves with wire mesh screens (Retsch GmbH, Haan, Germany). One had openings of 100 μm and the other had openings of 710 μm. These sieves were placed into a Retsch AS 200 sieve shaker and they were agitated at a setting of 1 mm (half-amplitude) for 10 minutes. Any material that was captured between the two screens was retained and used as CE-1. PARTICLE B was classified as described for CE-1, with the exception that it was not hammermilled, and the sieved material was collected as CE-2.

Comparative Example 3 (CE-3): DI water, BINDER A and BINDER B were combined in amounts indicated in Table 3. These materials were mixed in a KitchenAid KFC3511GA food processor (Whirlpool Corporation, Benton Charter Township, MI). During addition of the binder and water suspension, the material was periodically broken up using a spatula to ensure uniform distribution of the binder. After mixing, the agglomerates were heated at 50° C. overnight for drying. Dried agglomerates were classified using two sieves with wire mesh screens (Retsch GmbH, Haan, Germany), the first with 710-μm openings and second with 100-μm openings. These sieves were placed into a Retsch AS 200 sieve shaker, and they were agitated at a setting of 1 mm (half-amplitude) for 10 minutes. Any agglomerated material that passed through the 710-μm screen and was blocked by the 100-μm screen was used.

Comparative Example 4 (CE-4): PE-3 was used as CE-4.

Properties of EX-1 through EX-6 and CE-3 are presented in Table 4. Properties of EX-1 through EX-6 and CE-1 through CE-4 are presented in Table 5.

### Example 7 (EX-7) and Comparative Examples 5 and 6 (CE-5 and CE-6): Integration of Filler into a Nonwoven Fiber Layer

For Example 7 (EX-7) and Comparative Examples 5 and 6 (CE-5 and CE-6), nonwoven melt blown webs were prepared by a process similar to that described in Wente, Van A., “Superfine Thermoplastic Fibers” in Industrial Engineering Chemistry, Vol. 48, pages 1342 et seq. (1956), and in Report No. 4364 of the Naval Research Laboratories, published May 25, 1954 entitled “Manufacture of Superfine Organic Fibers” by Wente, Van. A. Boone, C. D., and Fluharty, E. L., with the exception that a drilled die was used to produce the fibers. RESIN A was extruded through the die into a high velocity stream of heated air which drew out and attenuated polypropylene blown microfibers prior to their solidification and collection. If indicated in Table 6, filler was fed into the stream of polypropylene blown microfibers, according to the method of U.S. Pat. No. 3,971,373 (Braun). The blend of polypropylene blown microfibers and filler, if used, was collected in a random fashion on a nylon belt. The web was then removed from the nylon belt. Properties of EX-7, CE-5, and CE-6 are presented in Tables 6 and 7.

### Examples 8 and 9 (EX-8 and EX-9): Integration of Filler into Microperforated Film

For Examples 8 and 9 (EX-8 and EX-9), specific size cuts of filler were used to minimize oversized and undersized particles relative to the film perforation sizes. EX-4 was classified using 8 inch (20.3 cm) diameter round wire mesh screens (obtained from Retsch GmbH, Haan, Germany) having either 300 μm and 400 μm openings or 150 μm and 200 μm openings, by placing the material and the screens into a vibratory sieve shaker (obtained under the trade designation “AS 200” from Retsch GmbH, Haan, Germany), and agitating at an amplitude setting of 1 mm for 10 minutes.

Discs of PE-4 and PE-5 were punched out with a 68 mm diameter punch. For each disc, particles indicated in Table 8 were spread into the larger-aperture side by hand. Particles then filled the aperture. PE-4 was used for EX-8 and PE-5 was used for EX-10.

### Comparative Examples 7 and 8 (CE-7 and CE-8): Films Only

Discs of PE-4 (for CE-7) and discs of PE-5 (for CE-8) were punched out with a 68 mm diameter punch.

Properties of EX-8, EX-9, CE-7, and CE-8 are presented in Table 8 and Table 9.

TABLE 3
Ingredients and Quantities

| | | | | | | | Secondary |
|---|---|---|---|---|---|---|---|
| | Silica | | | Clay | Solvent/Binder | | Agglomeration |
| | PE-1 | PE-2 | Particle | Binder | Binder | DI Water | Second Agglom. (Y/N); |
| Example | (g) | (g) | C (g) | B (g) | A (g) | (g) | water added (g) |
| EX-1 | 56.25 | 0 | 0 | 18.75 | 15.1 | 40.1 | Y, 49.5 |
| EX-2 | 0 | 56.25 | 0 | 18.75 | 15.1 | 27.4 | Y, 40 |
| EX-3 | 0 | 0 | 18.75 | 56.25 | 5.03 | 17.47 | N |
| EX-4 | 0 | 0 | 56.25 | 18.75 | 15.1 | 41.1 | Y, 60 |
| EX-5 | 0 | 90 | 0 | 0 | 18.12 | 60.38 | Y, 30 |
| EX-6 | 460 | 0 | 0 | 1840 | 463 | 380 | Y, 560* |
| CE-3 | 0 | 0 | 0 | 75 | 5.03 | 17.47 | N |

*2060 g of original material recovered

TABLE 4
Characterization

| | | | Surface Area/Pore Volume Characterization | | | |
|---|---|---|---|---|---|---|
| | Density Measurements | | | Micro/Mesopore | Micro/Mesopore | Total Pore |
| | Bulk | Skeletal | Surface Area | Volume (DFT | Surface Area (DFT | Volume (N₂, |
| Example | Density (g/mL) | Density (g/mL) | (MBET, N₂, 77K, m²/g) | N₂, 77K, mL/g) | N₂, 77K, m²/g) | 77 K, mL/g) |
| EX-1 | 0.59 | 1.99 | 294 | 0.52 (meso) | 266 (meso) | 0.58 |
| EX-2 | 0.57 | 1.97 | 409 | 0.06 (micro), | 199 (micro), | 0.29 |
| | | | | 0.18 (meso) | 209 (meso) | |
| EX-3 | 0.61 | 2.28 | 72 | 0.37 (meso) | 69 (meso) | 0.48 |
| EX-4 | 0.27 | 2.00 | 179 | 0.92 (meso) | 174 (meso) | 0.96 |
| EX-5 | 0.59 | 1.81 | 636 | 0.11 (micro), | 398 (micro), | 0.37 |
| | | | | 0.24 (meso) | 293 (meso) | |
| EX-6 | 0.76 | 2.23 | 99 | 0.17 (meso) | 85 (meso) | 0.27 |
| CE-1 | 0.53 | 2.10 | 480 | 0.82 (meso) | 481 (meso) | 0.84 |
| CE-2 | 0.76 | 2.09 | 740 | 0.13 (micro), | 435 (micro), | 0.39 |
| | | | | 0.24 (meso) | 306 (meso) | |
| CE-3 | 0.84 | 2.49 | 20 | NA | NA | 0.19 |
| CE-4 | 0.55 | NA | 1106 | 0.42 (micro) | 1109 (micro), | 0.43 |
| | | | | 0.01 (meso) | 2 (meso) | |

TABLE 5
Normal Incidence Acoustic Absorption for Packed Bed Configuration

| | 124 Hz | 160 Hz | 200 Hz | 248 Hz | 316 Hz | 400 Hz | 500 Hz | 632 Hz |
|---|---|---|---|---|---|---|---|---|
| Example | (α) | (α) | (α) | (α) | (α) | (α) | (α) | (α) |
| EX-1 | 0.06 | 0.06 | 0.07 | 0.13 | 0.25 | 0.30 | 0.30 | 0.30 |
| EX-2 | 0.06 | 0.11 | 0.27 | 0.32 | 0.33 | 0.33 | 0.34 | 0.34 |
| EX-3 | 0.07 | 0.08 | 0.11 | 0.19 | 0.26 | 0.30 | 0.31 | 0.33 |
| EX-4 | 0.04 | 0.07 | 0.11 | 0.19 | 0.28 | 0.34 | 0.39 | 0.40 |
| EX-5 | 0.06 | 0.07 | 0.08 | 0.11 | 0.18 | 0.28 | 0.33 | 0.37 |
| EX-6 | 0.08 | 0.09 | 0.10 | 0.16 | 0.27 | 0.30 | 0.30 | 0.30 |
| CE-1 | 0.03 | 0.06 | 0.11 | 0.21 | 0.28 | 0.27 | 0.26 | 0.24 |
| CE-2 | 0.08 | 0.09 | 0.11 | 0.12 | 0.17 | 0.22 | 0.27 | 0.33 |
| CE-3 | 0.06 | 0.06 | 0.09 | 0.14 | 0.21 | 0.26 | 0.30 | 0.35 |
| CE-4 | 0.11 | 0.25 | 0.40 | 0.43 | 0.40 | 0.38 | 0.39 | 0.39 |

| | 800 Hz | 1000 Hz | 1248 Hz | 1600 Hz | 2000 Hz | 2500 Hz |
|---|---|---|---|---|---|---|
| Example | (α) | (α) | (α) | (α) | (α) | (α) |
| EX-1 | 0.30 | 0.30 | 0.33 | 0.35 | 0.37 | 0.42 |
| EX-2 | 0.38 | 0.38 | 0.41 | 0.43 | 0.46 | 0.49 |
| EX-3 | 0.34 | 0.35 | 0.37 | 0.40 | 0.41 | 0.44 |
| EX-4 | 0.44 | 0.45 | 0.48 | 0.51 | 0.53 | 0.57 |
| EX-5 | 0.40 | 0.41 | 0.42 | 0.43 | 0.46 | 0.49 |
| EX-6 | 0.30 | 0.31 | 0.33 | 0.35 | 0.37 | 0.40 |
| CE-1 | 0.25 | 0.25 | 0.26 | 0.28 | 0.30 | 0.32 |
| CE-2 | 0.39 | 0.45 | 0.49 | 0.52 | 0.54 | 0.52 |
| CE-3 | 0.38 | 0.40 | 0.42 | 0.44 | 0.47 | 0.47 |
| CE-4 | 0.41 | 0.41 | 0.45 | 0.48 | 0.53 | 0.58 |

TABLE 6
Loaded BMF and Comparative Informationr

| | | | | | | Pressure | | | | | |
|---|---|---|---|---|---|---|---|---|---|---|---|
| | | Base Web | | Total Web | | drop | | | | | |
| Example or | | Basis | | Basis | Nonwoven | (mm H₂O) | Fiber | Filler | Filler | Nonwoven | |
| Comparative | | Weight | EFD | Weight | Thickness 1 | @ 32/85 | Solidity | Loading | Loading | Thickness 2 | AFR |
| Example | Filler | (GSM) | (μm) | (GSM) | (mm) | 1 pm | (%) | (wt %) | (vol %) | (mm) | (MKS Rayls) |
| EX-7 | EX-6 | 530 | 5.6 | 819 | 13 | 66 | 6.5 | 35.3 | 1.5 | 8.9 | 4520 |
| CE-5 | PE-3 | 529 | 4.8 | 786 | 12.6 | 95 | 6.3 | 32.7 | 1.3 | 9.3 | 7120 |
| CE-6 | None | 763 | 4.6 | 763 | 12.0 | 68 | 7.4 | N/A | N/A | 11.3 | 10920 |

TABLE 7
Alpha Cabin Testing of Articles

| Example or | | | | | | | | |
|---|---|---|---|---|---|---|---|---|
| Comparative | Absorption at Frequency (α) | | | | | | | |
| Example | 400 Hz | 500 Hz | 630 Hz | 800 Hz | 1000 Hz | 1250 Hz | 1600 Hz | 2000 Hz |
| EX-7 | 0.13 | 0.31 | 0.50 | 0.78 | 0.91 | 0.95 | 0.93 | 0.93 |
| CE-5 | 0.13 | 0.35 | 0.61 | 0.91 | 0.91 | 0.89 | 0.83 | 0.81 |
| CE-6 | 0.13 | 0.37 | 0.75 | 1.04 | 0.86 | 0.77 | 0.71 | 0.73 |

| Example or | | | | | | | |
|---|---|---|---|---|---|---|---|
| Comparative | Absorption at Frequency (α) | | | | | | |
| Example | 2500 Hz | 3150 Hz | 4000 Hz | 5000 Hz | 6300 Hz | 8000 Hz | 1000 Hz |
| EX-7 | 0.92 | 0.87 | 0.87 | 0.87 | 0.90 | 0.89 | 0.92 |
| CE-5 | 0.80 | 0.77 | 0.80 | 0.79 | 0.84 | 0.86 | 0.88 |
| CE-6 | 0.77 | 0.79 | 0.82 | 0.81 | 0.83 | 0.84 | 0.85 |

TABLE 8
Loaded Microperforated Film and Comparative Information

| | | Particle | Film | | |
|---|---|---|---|---|---|
| | | (range of longest | Basis | | |
| | | particle | Wt | wt % | AFR |
| | Film | dimension, μm) | (GSM) | Particles | (MKS Rayls) |
| CE-7 | PE-4 | None | 930 ± 5 | 0 | 40 |
| EX-8 | PE-4 | EX-4 | 986 | 6 | *120 [500 um], |
| | | (300-400) | | | 1500 [300 um] |
| CE-8 | PE-5 | None | 314 ± 1 | 0 | 100 |
| EX-9 | PE-5 | EX-4 | 368 | 15 | **150 [200 um], |
| | | (150-200) | | | 1700 [100 um] |

*Measured for spherical zirconia particles in PE-1 with noted particle diameters.
**Measured for spherical zirconia particles in PE-2 with noted particle diameters.

TABLE 9
Acoustic Test Results on Perforated Films

| | CE-7 | EX-8 | CE-8 | EX-9 |
|---|---|---|---|---|
| α (200 Hz) | 0.04 | 0.06 | 0.06 | 0.04 |
| α (250 Hz) | 0.03 | 0.07 | 0.05 | 0.04 |
| α (315 Hz) | 0.03 | 0.09 | 0.04 | 0.06 |
| α (400 Hz) | 0.03 | 0.13 | 0.05 | 0.09 |
| α (500 Hz) | 0.05 | 0.16 | 0.07 | 0.15 |
| α (630 Hz) | 0.07 | 0.24 | 0.10 | 0.21 |
| α (800 Hz) | 0.10 | 0.42 | 0.14 | 0.29 |
| α (1000 Hz) | 0.15 | 0.63 | 0.20 | 0.48 |
| α (1250 Hz) | 0.23 | 0.84 | 0.29 | 0.65 |
| α (1600 Hz) | 0.37 | 0.96 | 0.41 | 0.84 |
| α (2000 Hz) | 0.51 | 0.96 | 0.54 | 0.97 |
| α (2500 Hz) | 0.58 | 0.88 | 0.66 | 0.99 |

Thus, the present disclosure provides, among other things, acoustic article and methods of making the same. Various features and advantages of the present disclosure are set forth in the following claims.

1. An acoustic article comprising:
a porous layer; and
an acoustic absorbing filler embedded in the porous layer, the acoustic absorbing filler comprising agglomerates, the agglomerates comprising porous amorphous silica particles and a binder,
wherein the acoustic absorbing filler has a median sieved particle size of 100 μm to 2000 μm, and
wherein the acoustic article has a normal incidence acoustic absorption of no less than 0.09 α at 400 Hz.

2. The acoustic article of claim 1, wherein the acoustic absorbing filler has a median sieved particle size of 100 μm to 710 μm.

3. The acoustic article of claim 1, wherein the porous amorphous silica particles comprise a fumed silica, a silica gel, or combinations thereof.

4. The acoustic article of claim 1, wherein the porous amorphous silica particles are mesoporous.

5. The acoustic article of claim 1, wherein the porous amorphous silica particles are microporous.

6. The acoustic article of claim 1, where the acoustic absorbing filler comprises 15 to 90 wt % porous amorphous silica particles.

7. The acoustic article of claim 1, wherein the acoustic absorbing filler comprises 10 to 85 wt % binder.

8. The acoustic article of claim 1, wherein the binder comprises clay, liquid alkali silicates, silicon alkoxides, boehmite, pseudoboehmite, lignin, lignosulfonates, polyacrylates, acrylic-copolymers, polyvinylpyrrolidone, polyvinyl alcohol, acrylamides, styrenic polymers, butadiene co-polymers, polyethylene glycol, polyethylene oxide, cellulosics, polysaccharides or combinations thereof.

9. The acoustic article of claim 1, wherein the binder comprises a polyacrylate.

10. The acoustic article of claim 1, wherein the binder comprises clay.

11. The acoustic article of claim 1, wherein the porous layer is a perforated film having a plurality of perforations, wherein the acoustic absorbing filler resides in at least a portion of the plurality of perforations.

12. The acoustic article of claim 1, wherein the porous layer is a packed particle bed comprising the acoustic absorbing filler.

13. The acoustic article of claim 12, wherein the acoustic article has a normal incidence acoustic absorption of no less than 0.2 α at 400 Hz.

14. The acoustic article of claim 1, wherein the porous layer is a nonwoven fibrous layer.

15. The acoustic article of claim 14, wherein the nonwoven fibrous layer comprises blown microfibers (BMF).

16. The acoustic article of claim 14, wherein the acoustic article has a normal incidence acoustic absorption of no less than 0.1 α at 400 Hz.

17. A method of making the acoustic article of claim 1 comprising embedding the acoustic absorbing filler into the nonwoven fibrous layer.

18. An acoustic absorbing filler comprising:
agglomerates comprising porous amorphous silica particles and a binder,
wherein the acoustic absorbing filler has a median sieved particle size of 100 μm to 710 μm.

19. The acoustic absorbing filler of claim 18, wherein the binder comprises a polyacrylate, clay or combinations thereof.

20. The acoustic absorbing filler of claim 18, wherein the porous amorphous silica particles comprise a fumed silica, a silica gel, or combinations thereof.
